(19) United States
(12) Patent Application Publication
(10) Pub. No.: US 2014/0306531 A1
(43) Pub. Date: Oct. 16, 2014

(54) LIGHTING BALLAST FOR USE WITH VARIABLE DC POWER DISTRIBUTION

(71) Applicant: Robert Bosch GmbH, Stuttgart (DE)

(72) Inventors: Scott M. Averitt, Roseville, MI (US); Dusan Brhlik, Novi, MI (US); Jan Riedel, Guendelbach (DE)

(73) Assignee: Robert Bosch GmbH, Stuttgart (DE)

(21) Appl. No.: 14/250,922

(22) Filed: Apr. 11, 2014

Related U.S. Application Data
(60) Provisional application No. 61/811,206, filed on Apr. 12, 2013.

(51) Int. Cl. H02J 1/00; H02M 3/04

(52) U.S. Cl. CPC H02J 1/00; H02M 3/04
USPC 307/43; 323/282

(57) ABSTRACT

Systems and methods are described for selectively applying DC power from a variable voltage DC power bus to a DC load. The ballast includes at least one switch coupled between the DC power bus and the DC load. A processor is coupled to the at least one switch and controls the operation of the at least one switch. A non-transient computer-readable memory stores instructions that are executed by the processor to control the operation of the processor. The processor determines a voltage on the variable voltage DC power bus and defines a pulse-width modulate power control signal based on the determined voltage. The at least one switch is then operated based on the pulse-width modulated power control signal to apply DC power from the DC power bus to the DC load at a first frequency.

### RELATED APPLICATIONS

This application claims the benefit of U.S. Provisional Patent Application No. 61/811,206, filed Apr. 12, 2013, the entire contents of which are incorporated herein by reference.

### BACKGROUND

The present invention relates to systems and methods of distributing DC power such as, for example, from solar panels to electrical devices. Traditional solar panel installations use an AC inverter in order to convert the high voltage DC electricity supplied from the solar panels into 60 Hz AC voltage that can then be directly tied to the utility grid. The AC voltage is then distributed to the loads within the building or back to the utility grid.

### SUMMARY

Many electronic devices used today do not directly use the 60 Hz AC voltage that is distributed throughout buildings and households through the power grid. Instead, the devices first convert the 60 Hz AC voltage into high voltage DC. The DC voltage is then used to power the device. However, every time electrical power is transformed from DC to AC or from AC to DC there are losses in efficiency that are given off in the form of heat. These losses from DC to AC and from AC to DC conversions can add up to between 8-12% of the power that could have been delivered from a solar array.

The systems described herein improve the efficiency of such power systems by supplying the high voltage DC power generated from a solar panel array directly to DC-powered devices. This type of DC microgrid installation does not require an inverter as the DC voltage is distributed directly to the loads (i.e., the DC-powered devices), which reduces overall system cost and complexity while also eliminating a notable source of power loss. However, the downside of not using an inverter is that modern inverters typically have functionality built into it them provide Maximum Power Point Tracking (“MPPT”) for the solar array. MPPT is used in order to maximize the power supplied by the solar array by adjusting the output voltage of the solar array in order to deliver the maximum output power. This functionality could be restored by adding individual MPPT modules on the solar arrays, but this would add to system cost, lowers efficiency due to a DC-to-DC conversion, and reduces reliability by adding components.

Instead, various embodiments described herein provide a method of control for a lighting ballast to allow it to be used in a system with variable DC power distribution. The solar array MPPT functionality is realized by varying the loads in order to reach the optimum operating voltage of the solar array. A supplemental DC power supply is added to the system in order to accomplish the MPPT function. This same power supply is used to power the loads when the solar array can't produce the necessary power requirements demanded by the loads. Thus, MPPT functionality is provided without requiring a DC-to-AC inverted or a separate MPPT module for each solar array. Furthermore, system provides for consistent load performance that is not affected by the varying DC voltage supplied to them. In this way, for example, the occupants of the building do not notice any change in behavior of their surrounding environment.

In one embodiment, the invention provides a microgrid system comprising a DC power bus, a solar array, a controllable DC power supply, and a lighting ballast. The solar array is coupled to the DC power bus and configured to provide DC power to the DC power bus. The controllable DC power supply is configured to apply a variable voltage to the DC power bus. In some embodiments, the variable voltage of the controllable DC power supply is controlled to achieve a maximum power point. The lighting ballast is configured to control an amount of power applied to a DC load (such as, for example, a light source). The lighting ballast monitors the variable voltage of the DC power bus and defines a pulse width modulated power control signal based on the voltage of the DC power bus. The voltage of the DC power bus is controllable applied to the DC load based on the pulse-width modulated power control signal.

In some embodiments, the amount of power applied from the DC power bus to the DC load is adjusted by varying a frequency at which the DC power is applied to the DC load. In other embodiments, the amount of power applied from the DC power bus to the DC load is adjusted by varying a DC power duty cycle.

In another embodiment, the invention provides a ballast for selectively applying DC power from a variable voltage DC power bus to a DC load. The ballast includes at least one switch coupled between the DC power bus and the DC load. A processor is coupled to the at least one switch and controls the operation of the at least one switch. A non-transient computer-readable memory stores instructions that are executed by the processor to control the operation of the processor. The processor determines a voltage on the variable voltage DC power bus and defines a pulse-width modulate power control signal based on the determined voltage. The at least one switch is then operated based on the pulse-width modulated power control signal to apply DC power from the DC power bus to the DC load at a first frequency.

Other aspects of the invention will become apparent by consideration of the detailed description and accompanying drawings.

### BRIEF DESCRIPTION OF THE DRAWINGS

FIG. 1 is a block diagram of a DC distribution system according to one embodiment.

FIG. 2 is a flowchart of a method for controlling the power provided to a light in the system of FIG. 1.

FIG. 3 is a schematic diagram of a ballast circuit configured to implement the method of FIG. 2 in the DC distribution arrangement of FIG. 1.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

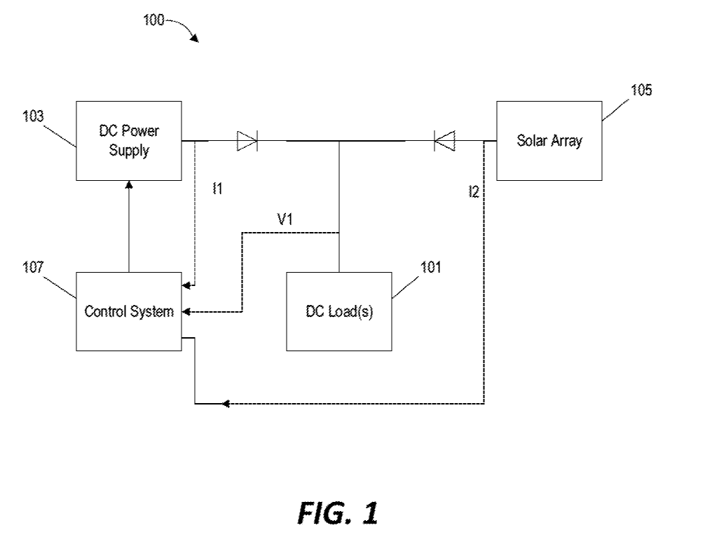

FIG. 1 illustrates a power distribution system 100 that includes a DC power supply 103 and a solar array 105. The DC power supply 103 may be configured to convert from the public 60 Hz AC grid into DC power. Alternatively, the DC power supply 103 can include any power source that is capable of providing DC power to the system at a specified voltage including, for example, a UPS supply, micro turbine, generator, fuel cell, or wind generator. The power from the DC power supply 103 is combined with the power output from a solar array 105 on a DC power bus. Although the examples discussed herein specifically address a solar array, the power management mechanisms and ballast circuits described below can be adapted to regulate varying DC power provided by another source that would benefit from MPPT tracking functionality.

One or more DC loads 101 draw power from the DC power supply 103 and the solar array 105 through the DC bus. The DC load(s) 101 include an electronic ballast circuit to provide signal conditioning for an applicable light source such as, for example, induction, fluorescent, and LED light sources. In other constructions, other types of DC loads, such as, for example, HVAC equipment, pumps, fans, compressors, and inverters, are included in addition to or instead of the light source.

A control system 107 monitors one or more system voltages and one or more system currents and provides a control signal to regulate the operation of the DC power supply 103. In the example of FIG. 1, the control system 107 monitors the voltage provided to the DC load 101, the current output from the DC power supply 103, and the current output from the solar array 105. In some constructions, the control system 107 determines a required operating voltage of the system using an MPPT algorithm and the various input voltages and currents of both the solar array 105 and the DC power supply 103. As a result, the DC voltage provided to the DC loads 101 is varies. Without further mitigation, this varying DC voltage would cause the light output (e.g., of the DC load 101) to raise or lower as a function of the input voltage. This varying light output would produce an undesirable effect to the occupants of the building (e.g., flickering lights).

To prevent this undesirable effect, the DC electronics ballast in the DC load 101 compensates for this varying DC system voltage in such a way that output power provided to the lamp remains constant regardless of the input DC voltage. In some constructions, the ballast is configured to operate one or more switches (e.g. FETs) that control whether power is applied to the lamp. The frequency at which the switches are operated can be controllably adjusted such that the resonant tank circuit of the lamp shifts away from its resonant point. This can be done by increasing or decreasing the frequency depending on the resonant point set by the ballast circuit. By varying this frequency as a function of the DC input voltage, the output power can be maintained at a relatively constant level thus not changing the light output of the lamp for different DC input voltages.

In other constructions, the ballast pulse-width modulates the output with a varying duty cycle that is a function of the DC input voltage. Higher DC input voltages results in lower duty cycling of the fundamental frequency in order to achieve the same overall average light output. One advantage of this method is that it is more easily applied to LED lamp outputs than the method described above. This method also makes it easier to optimize the electronics for a given fundamental frequency.

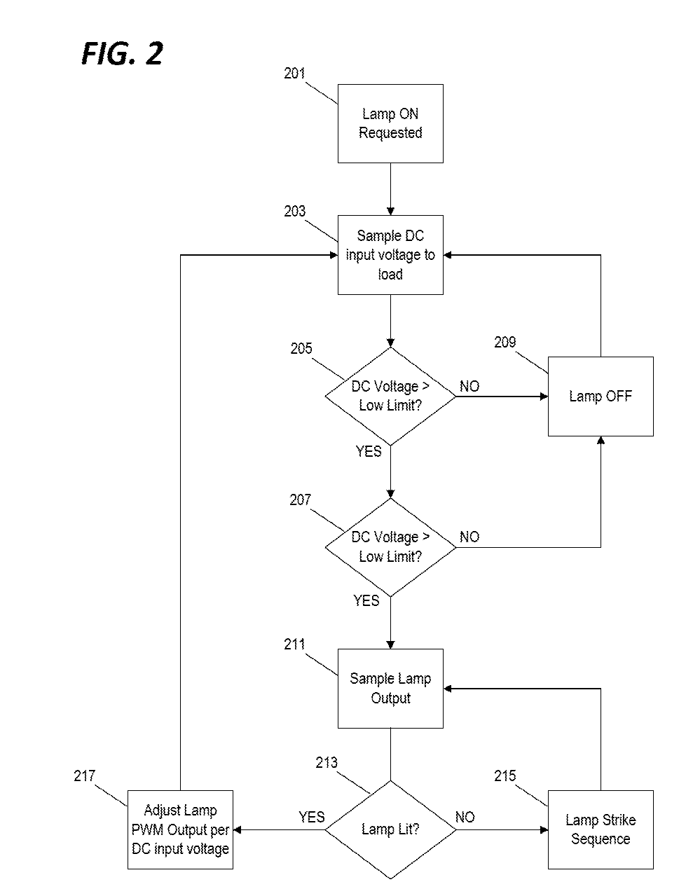

FIG. 2 illustrates a method of controlling a lamp based on the DC input voltage provided to the DC load 101. As described in further detail below, this method is implemented by the ballast circuit of the DC load 101. When a “lamp ON” is requested (e.g., a wall switch is turned to the “ON position” or a home automation system calls for a light to be turned on) (step 201), the ballast system samples the DC input voltage provided to the load (step 203). If the DC voltage is below a lower limit (step 205) or above an upper limit (step 207), the lamp is either turned off or remains in the “off” state (step 209). This ensures that the voltage provided to the lamp is within a defined range of operable voltages.

If the DC input voltage provided to the load is within the defined range, the ballast circuit samples the lamp output (step 211) and determines whether the lamp is lit (step 213). If the lamp is not already lit, the ballast control circuit executes a lamp strike sequence (step 215) to light the lamp. If, however, the lamp is already lit, the ballast control system uses pulse width modulation to adjust the output of the lamp based on the DC input voltage (step 217). The ballast control system then again samples the DC input voltage (step 203) and continues to adjust the lamp output based on the DC input voltage until the lamp is turned off or until the DC input voltage leaves the defined range.

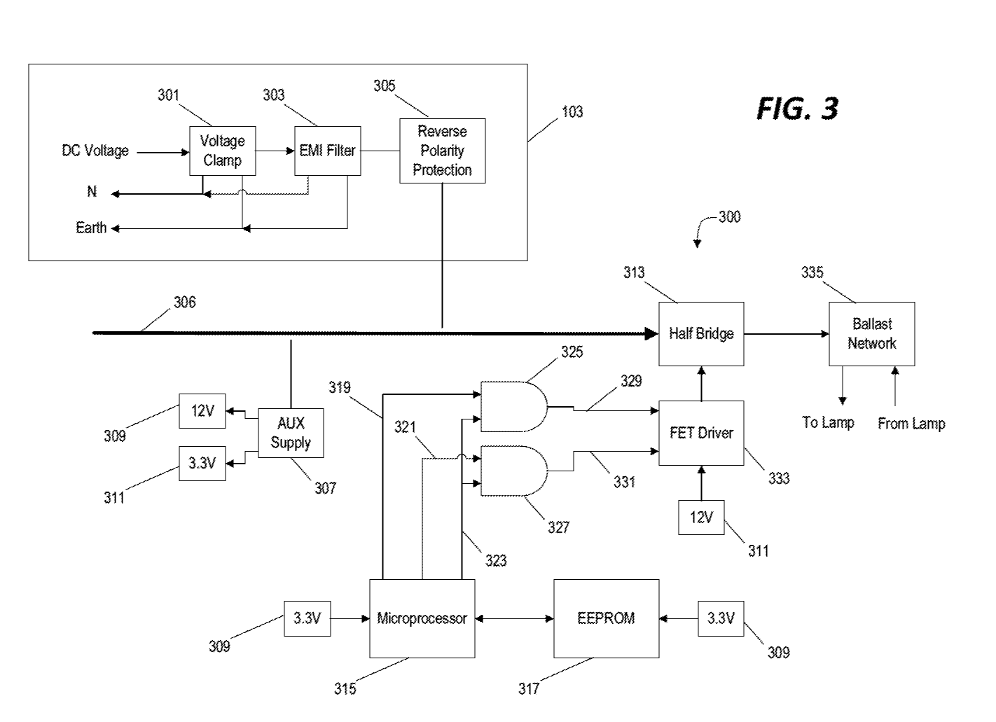

FIG. 3 illustrates the DC microgrid system 100 of FIG. 1 in further detail. The DC power supply 103 couples a DC voltage source (i.e., the DC converted power from the public power grid or another source) to a voltage clamp 301 to maintain the output power at a constant voltage. An EMI filter 303 filters any electromagnetic interference/noise and the filtered DC power is provided through a reverse polarity protection module 305 to a DC power bus 306. The DC power bus 306 also receives DC power from other sources, such as the solar array (not pictured), as discussed above in reference to FIG. 1. The reverse polarity protection module 305 (such as, for example, a diode) prevents DC power from the DC power bus 306 from flowing the opposite direction into the DC power supply 103.

An auxiliary power supply module 307 draws power from the DC power bus 306 and produces a 12V auxiliary power source 309 and a 3.3V auxiliary power source 311 which are used to operate portions of the ballast control system as described in further detail below. In some constructions, a separate auxiliary power supply module 307 is connected directly to the DC power bus 306 and provides operating power to each ballast system connected to the DC power bus 306. In other constructions, the auxiliary power supply module 307 is incorporated into the same hardware (i.e., housing) as a single ballast control system 300.

The ballast control system 300 is operated by a microprocessor 315. The microprocessor 315 is powered by the 3.3V auxiliary power source 311 and executes instructions stored on a memory unit such as EEPROM 317. In this example, EEPROM 317 is also powered by the 3.3V auxiliary power source 311. In this example, the microprocessor 315 provides three pulse-width modulated control outputs—a high-side PWM signal 319, a low-side PWM signal 321, and a dimming PWM signal 323. The three PWM control outputs are provided to a pair of AND gates 325, 327. The first AND gate 325 produces a high-side FET control signal 329 based on the high-side PWM signal 319 and the dimming PWM signal 323. Similarly, the second AND gate 327 produces a low-side FET control signal 331 based on the low-side PWM signal 321 and the dimming PWM signal 323.

The high-side FET control signal 329 and the low-side FET control signal 331 are both provided to a FET driver module 333 which operates a plurality of switches within a half-bridge module 313. The FET driver 333 receives power from the 12V auxiliary power source 309 and opens the high-side switch(es) of the half bridge module 313 based on the high-side FET control signal 329. Similarly, the FET driver 333 opens the low-side switch(es) of the half bridge module 313 based on the low-side FET control signal 331.

The state of the high-side and low-side switches of the half bridge module 313 control whether (and how) power is provided from the DC power bus 306 to the ballast network 335 and, subsequently, to the lamp itself As described above in reference to FIG. 2, the microprocessor 315 adjusts its output PWM signals based on the observed voltage on the DC power bus 306. In this example, the high-side PWM signal 319 and the low-side PWM signal 321 are generated to operate the half bridge to provide DC power from the DC power bus 306 to the ballast network (and the lamp) at a given frequency. The dimming PWM signal 323 is then used to adjust the duty cycle of the ballast system. Because of the AND gate configuration, the high-side PWM signal 319 is only passed through to the FET driver 333 (as the high-side FET control signal 329) when the dimming PWM signal 323 is high. Similarly, the low-side PWM signal 321 is only passed through to the FET driver 333 (as the low-side FET control signal 331) when the dimming PWM signal 323 is high. As a result, the switches of the half bridge module 313 operate to provide DC power to the lamp at a given frequency when the dimming PWM signal 323 is high. When the dimming PWM signal goes low, the switches of the half bridge module are opened and DC power is not delivered from the DC power bus 306 to the lamp. In this way, the total power provided to the lamp is controlled by using the dimming PWM signal 323 to control the duty cycle of the half-bridge module 313.

The same circuit can be used to control the power provided to the lamp by adjusting the fundamental frequency of the high-side PWM signal 319 and the low-side PWM signal 321. Instead of using the dimming PWM signal 323 to adjust the duty cycle, the dimming PWM signal 323 is held high. The microprocessor 315 then adjusts the frequency of the high-side PWM signal 319 and the frequency of the low-side PWM signal 321 to control the power applied to the lamp. This secondary control mechanism can aso be implemented by a simplified version of the circuit illustrated in FIG. 3. In the simplified circuit, the AND gates 325, 327 and the dimming PWM signal 323 can be omitted entirely such that the microprocessor 315 provides the high-side PWM signal 319 and the low-side PWM signal 321 directly to the FET driver 333.

Thus, the invention provides, among other things, a power distribution system for providing DC power directly from a solar array to a load (such as, for example, a light source) and a ballast control system that operates to provide consistent power to a load despite a varying DC voltage on a DC power bus. Various features and advantages of the invention are set forth in the following claims.

What is claimed is:

1. A microgrid system comprising:
a DC power bus;
a solar array coupled to the DC power bus and configured to provide DC power to the DC power bus;
a controllable DC power supply configured to apply a variable voltage to the DC power bus; and
a lighting ballast configured to control an amount of power applied to a DC load by
monitoring the variable voltage of the DC power bus,
defining a pulse width modulated power control signal based on the voltage of the DC power bus, and
controllably applying the voltage of the DC power bus to the DC load based on the pulse width modulated power control signal.

2. The microgrid system of claim 1, wherein the controllable DC power supply is further configured to
monitor a current of the solar array;
monitor a current of the controllable DC power supply;
monitor the voltage of the DC power bus;
determine a maximum power point voltage for the DC bus; and
adjust the voltage output of the DC power supply based on the determined maximum power point voltage.

3. The microgrid system of claim 1, wherein the lighting ballast is further configured to
determine whether the variable voltage of the DC power bus exceeds a maximum bus voltage threshold; and
turn off the DC load when the variable voltage of the DC power bus exceeds the maximum bus voltage threshold.

4. The microgrid system of claim 1, wherein the lighting ballast is further configured to
determine whether the variable voltage of the DC power bus does not exceed a minimum bus voltage threshold; and
turn off the DC load when the variable voltage of the DC power bus does not exceed the minimum bus voltage threshold.

5. The microgrid system of claim 1, wherein the lighting ballast includes at least one switch coupled between the DC power bus and the DC load.

6. The microgrid system of claim 5, wherein the lighting ballast
defines the pulse width modulated power control signal based on the voltage of the DC power bus by defining a switching frequency for the at least one switch based on the monitored variable voltage of the DC power bus, and
controllably applies the voltage of the DC power bus to the DC load by operating the at least one switch according to the switching frequency.

7. The microgrid system of claim 6, wherein the lighting ballast is further configured to
detect a change in the voltage of the DC power bus, and
adjust the amount of power applied to the DC load by adjusting the switching frequency based on the change in the voltage of the DC power bus.

8. The microgrid system of claim 5, wherein the lighting ballast
defines the pulse width modulated power control signal based on the voltage of the DC power bus by defining a DC power duty cycle for the DC load, and
controllably applied the voltage of the DC power bus to the DC load by operating the at lest one switch according to the DC power duty cycle.

9. The microgrid system of claim 8, wherein the lighting ballast is further configured to
detect a change in the voltage of the DC power bus, and
adjust the amount of power applied to the DC load by adjusting the DC power duty cycle based on the change in the voltage of the DC power bus.

10. The microgrid system of claim 1, wherein the lighting ballast includes a processor and non-transient computer-readable memory storing instructions executable by the processor.

11. The microgrid system of claim 1, wherein the lighting ballast includes:
a high-side switch couplable between the DC bus and the DC load;
a low-side switch couplable between the DC bus and the DC load;
a processor; and
a non-transient computer-readable memory storing instructions that, when executed by the processor, cause the lighting ballast to
generate a pulse-width modulated high-side switch control signal,
generate a pulse-width modulated low-side switch control signal, and
selectively couple the DC power bus to the DC load such that DC power from the DC power bus is applied to the DC load by operating the high-side switch based on the pulse-width modulated high-side switch control signal and operating the low-side switch based on the pulse-width modulated low-side switch control signal.

12. The microgrid system of claim 11, wherein the non-transient computer-readable memory stores instructions that, when executed by the processor, further cause the lighting ballast to
generate a pulse-width modulated dimming control signal, wherein the pulse-width modulated dimming control signal defines a DC power duty cycle based on the monitored voltage of the DC power bus, and
wherein the lighting ballast is configured to close the high-side switch only when the pulse-width modulated high-side switch control signal and the pulse-width modulated dimming control signal are both high.

13. A ballast for selectively applying DC power from a variable voltage DC power bus to a DC load, the ballast including
at least one switch coupled between the DC power bus and the DC load;
a processor coupled to the at least one switch to control the operation of the at least one switch; and
a non-transient computer-readable memory storing instructions that, when executed by the processor, cause the processor to
determine a voltage on the variable voltage DC power bus;
define a pulse-width modulated power control signal based on the determined voltage; and
operate the at least one switch based on the pulse-width modulated power control signal to apply DC power from the DC power bus to the DC load at a first frequency.

14. The ballast of claim 13, wherein the instructions, when executed by the processor, further cause the processor to
detect a change in the voltage on the variable voltage DC power bus,
adjust the frequency of the pulse-width modulated signal based on the detected change in the voltage, and
operate the at least one switch based on the adjusted pulse-width modulated power control signal to apply DC power from the DC power bus to the DC load at the adjusted frequency.

15. The ballast of claim 13, wherein the instructions, when executed by the processor, further cause the processor to
detect a change in the voltage on the variable voltage DC power bus,
adjust a DC power duty cycle based on the detected change in the voltage, and
operate the at least one switch based on the adjusted DC power duty cycle to control an amount of power applied to the DC load from the DC power bus.
